(19) United States
(12) Patent Application Publication
(10) Pub. No.: US 2020/0240424 A1
(43) Pub. Date: Jul. 30, 2020

(54) Surge determination and mitigation on Internal Combustion Engines

(71) Applicant: International Engine Intellectual Property Company , LLC, Lisle, IL (US)

(72) Inventors: Vishnu Vijayakumar, Aurora, IL (US); Rahul Dev Rajampeta, Naperville, IL (US); Dave William Slessor, Morrison, CO (US); Sabrina Niemann, Batavia, IL (US); Mike Padowski, Arlington Heights, IL (US)

(21) Appl. No.: 16/258,125

(22) Filed: Jan. 25, 2019

(51) Int. Cl. F04D 27/02; F02D 13/02; F02D 23/02; F02B 37/16; F02D 21/08; F02M 26/49; F02M 26/09

(52) U.S. Cl. CPC F04D 27/0223; F02D 13/0276; F02D 23/02; F02M 2026/005; F02D 21/08; F02M 26/49; F02M 26/09; F02B 37/16

(57) ABSTRACT

A vehicle having an engine system which can detect an expected compressor surge event while the compressor is operating in a stable region of a compressor map, and upon detecting the expected compressor surge event controlling one or more engine operating parameters to maintain compressor operation in the stable region of the compressor map without transgressing (or mitigating the transgression of) a compressor surge line on the compressor map which, if transgressed, may cause compressor surge to occur.

### TECHNICAL FIELD

This disclosure relates to an internal combustion engine which has at least a turbocharger (either single- or multiple-stage) and external exhaust gas recirculation (EEGR). Such an engine is commonly used as the powerplant of a motor vehicle such as a heavy truck.

### BACKGROUND

Supercharging a diesel engine which powers a large commercial motor vehicle, such as a heavy truck or a large bus, can improve engine/vehicle fuel economy and performance. A turbocharger is commonly used for supercharging such an engine. Commercially available turbochargers have either single or multiple stages. Two types of turbochargers are wastegate turbochargers and variable geometry turbochargers (VGT's).

In both types, a turbine in an engine exhaust system is powered by engine exhaust gas passing through the turbine to operate a compressor in an engine intake system. The turbine has an adjustment mechanism which controls how much heat energy in engine exhaust gas which has entered the turbine is converted into mechanical energy of rotation of a turbine wheel which is transmitted through a shaft to operate an impeller wheel of the compressor as the exhaust gas passes through the turbine. The adjustment mechanism is controlled by an actuator. The actuator is controlled by a turbocharger control strategy embodied in an engine controller to control the energy input from the turbine wheel to the impeller wheel of the compressor. The turbocharger control strategy is itself coordinated with control strategies for certain other engine system components.

Consequently, the compressor operates to continually create charge air at super-atmospheric pressure (boost pressure) in one or more engine intake manifolds by forcing compressed intake air into the engine intake manifold(s). As certain vehicle/engine operating conditions change, the magnitude of boost pressure is controlled to maintain compressor operation within a stable operating region of a compressor operating map. However, certain changes in vehicle/engine operating conditions may cause a compressor to begin to operate in an unstable region of a compressor operating map. A typical compressor operating map has two such unstable regions, a surge region and a choke region.

A typical compressor operating map is a two-dimensional representation of a three-dimensional topographical map. The two-dimensional representation has a horizontal axis corresponding to an x-axis and a vertical axis corresponding to a y-axis. The x-axis represents mass airflow through the compressor measured in any appropriate units of measurement, such as kg/sec, and the y-axis represents the pressure ratio of the compressor. Pressure ratio, a dimensionless parameter, is the ratio of compressor outlet pressure to compressor inlet pressure. A compressor surge line is a left boundary of a stable operating region of a compressor, and a compressor choke line is a right boundary of the stable operating region.

The three-dimensional topographical map has a z-axis which represents compressor operating efficiency. Within its stable operating region, a compressor will have different operating efficiencies for various combinations of pressure ratio and mass airflow through the compressor. Within the stable operating region of a typical topographical map, parallel planes which are perpendicular to the z-axis at various locations along the z-axis will intersect with the topographical surface of the map to define rings of generally similar shapes but different sizes. Consequently, compressor operating efficiency is the same at all points along a ring, while each ring represents a compressor efficiency based on its location along the z-axis. When such rings are projected onto the two-dimensional x, y plane at the origin of the z-axis, the rings appear as islands on a two-dimensional map. Hence, such rings are commonly referred to as efficiency islands.

In the compressor surge region, air pressure at the compressor outlet is greater than that which the compressor itself can physically maintain. That causes airflow being propelled toward the compressor outlet by the compressor's impeller wheel to back up and increase pressure which may stall the compressor. In addition to potential effects on engine performance, compressor surge may generate unwanted noise and vibration and may have undesired effects on engine/vehicle performance operation. Repeated occurrences of compressor surge may eventually damage the turbocharger and/or other components.

Compressor surge can occur for any of various reasons. For example, compressor surge may occur while an engine is being fueled to operate substantially at a load/speed condition where load and speed are substantially constant and a rapid or sudden change in operation of the engine and/or the vehicle rapidly or suddenly occurs. Examples of such changes in engine/vehicle operation which can cause compressor surge under certain conditions are downshifting of a vehicle's transmission, terminating operation of an engine exhaust brake, and terminating operation of vehicle cruise control, among others.

### SUMMARY

Engine/vehicle events which cause certain changes in certain operating parameters can be predictors of an expected turbocharger compressor surge event. Once an expected turbocharger compressor surge event has been predicted, minimum airflow through the compressor sufficient to prevent or mitigate compressor surge is calculated and becomes a target value for a strategy which is intended to prevent the surge from occurring or mitigate the degree of compressor surge. In one system, a turbine adjustment mechanism, such as vanes of a VGT turbocharger, may be controlled upon determination of a predicted surge condition to begin reducing boost pressure of charge air by reducing torque which the turbine is delivering to the compressor. Operation of an EGR valve may also be controlled to allow charge air to flow from the engine intake system through the EGR valve and into the engine exhaust system for entrainment with exhaust entering and passing through the turbocharger to thwart, or at least mitigate, the expected compressor surge event. Quantity and timing of engine fueling may also be controlled in certain ways in conjunction with EGR valve control and turbocharger control to mitigate or fully thwart the surge event. Any one, two or all three of these surge mitigating and/or eliminating controls may be used independently of one another or together in various combinations for various situations.

This disclosure describes engine systems comprising an internal combustion engine which has an intake manifold and an exhaust manifold and which develops output torque which is delivered through a drivetrain to drive wheels which propel a land vehicle such as a truck for example.

The engine system has an intake system, which includes the intake manifold and combustion chambers into which air that has passed through the intake system enters to combust with fuel that has also entered the combustion chambers to develop output torque, and further comprising, an exhaust system, including the exhaust manifold, for conveying products of combustion out of the engine system.

A turbocharger has a turbine operated by products of combustion conveyed through the exhaust system and a compressor in the intake system operated by the turbine for creating boost pressure for charge air entering the combustion chambers.

A control system processes data which can disclose an expected compressor surge event before compressor surge begins, and which, when processing of such data discloses an expected compressor surge event while the compressor is operating in a stable region of a compressor map, controls the engine system to maintain compressor operation in the stable region of the compressor map without transgressing a compressor surge line on the compressor map (or mitigating the degree and/or amount of transgression across the surge line) which, when transgressed, may cause compressor surge to occur.

By processing data which can predict an expected compressor surge event before compressor surge begins, the engine system performs a method for preventing compressor surge event, or at least mitigating compressor surge if compressor surge begins.

The foregoing summary is accompanied by further detail of the disclosure presented in the Detailed Description below with reference to the following drawings that are part of the disclosure.

### BRIEF DESCRIPTION OF THE DRAWINGS

FIG. 1 is a left side elevation view of a motor vehicle which is propelled by a turbocharged engine.

FIG. 2 is a two-dimensional example of a turbocharger operating compressor map.

FIG. 3 is general strategy diagram for thwarting turbocharger compressor surge.

FIG. 4 is a schematic diagram of an engine system in the vehicle of FIG. 1, including an engine controller which implements the strategy for thwarting turbocharger compressor surge.

FIG. 5 is a diagram of a compressor operating map useful in showing how the strategy can be effective in preventing compressor surge.

### DETAILED DESCRIPTION

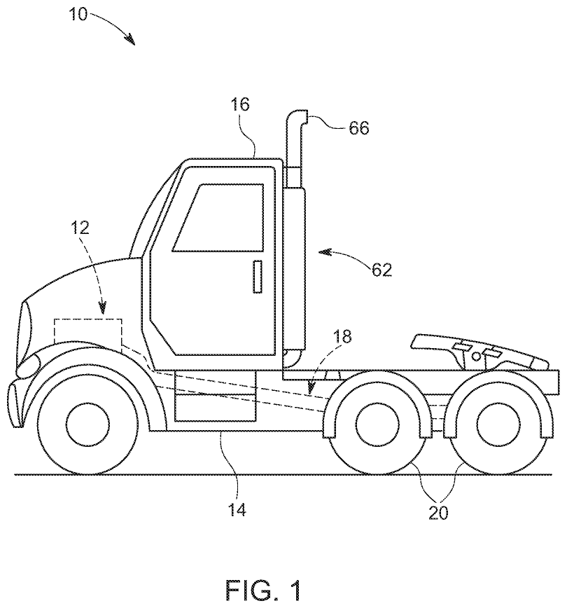

FIG. 1 shows a highway tractor 10 as an example of a motor vehicle which is propelled by a turbocharged diesel engine 12 mounted on a chassis frame 14 of highway tractor 10. A driver's cab 16 is also mounted on chassis frame 14 rearward of engine 12. A drivetrain 18 couples engine 12 to rear drive wheels 20 for propelling highway tractor 10 on an underlying road surface.

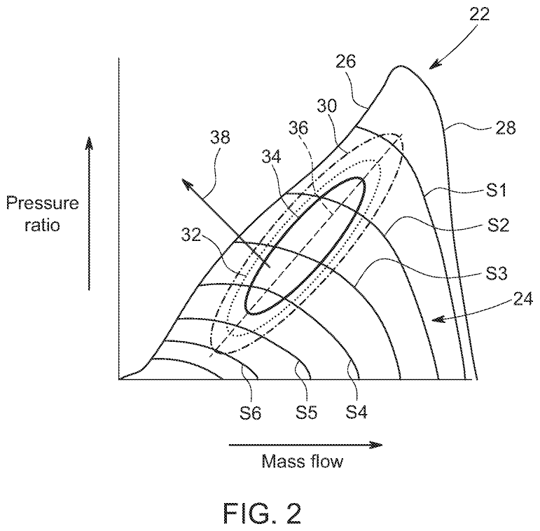

FIG. 2 shows a two-dimensional example of a turbocharger compressor map 22 of an engine system which has been empirically derived in conventional fashion. Compressor map 22 has a horizontal axis which represents mass airflow through the compressor and a vertical axis which represents compressor pressure ratio. A stable operating region 24 for the compressor is bounded on the left of FIG. 2 by a compressor surge line 26, and on the right by a compressor choke line 28.

A third dimension which represents compressor operating efficiency is described in the two-dimensional x, y plane, as explained earlier, by a multitude of efficiency islands within stable operating region 24. The perimeter of each efficiency island is an endless line, or ring, representing a specific value of compressor operating efficiency. Three examples of efficiency islands are shown by rings 30, 32, and 34 of progressively smaller size. The zone inside ring 34 is a zone of greater efficiency in comparison to the zone of ring 32 lying outside ring 34, and similarly, the zone of ring 32 lying outside ring 34 is a zone of greater efficiency in comparison to the zone of ring 30 lying outside ring 32. A broken line 36 represents a line of greatest compressor operating efficiency and is sometimes referred to as the spine of a compressor efficiency map. For greatest compressor operating efficiency at all engine speeds, it is desirable that the turbocharger operate at locations along or near the spine.

Compressor map 22 shows that within stable operating region 24 a compressor can have various operating efficiencies which are correlated with pressure ratio and mass airflow through the compressor. A location within region 24 at which a compressor operates depends on certain parameters including speed at which the engine is operating. For achieving both stable compressor operation and best compressor efficiency as engine/vehicle operation changes, a turbocharger should operate controlled within region 24 to maintain compressor operation on or close to spine 36 of compressor map 22. Compressor map 22 contains several speed lines S1, S2, S3, S4, S5, and S6, each representing a particular compressor speed, and showing that good compressor efficiency can be attained at different speeds.

However, certain changes in engine/vehicle operation may cause locations at which the compressor operates on the map to move out of stable operating region 24. When compressor operation transgresses surge engine 26, as suggested by arrow 38, compressor operation becomes unstable with boost pressure of charge air becoming greater than pressure which the compressor can maintain and the engine being unable to consume any more charge air. The boost pressure then causes reverse flow of charge air into the compressor through the compressor outlet accompanied by the effects and potential consequences mentioned above.

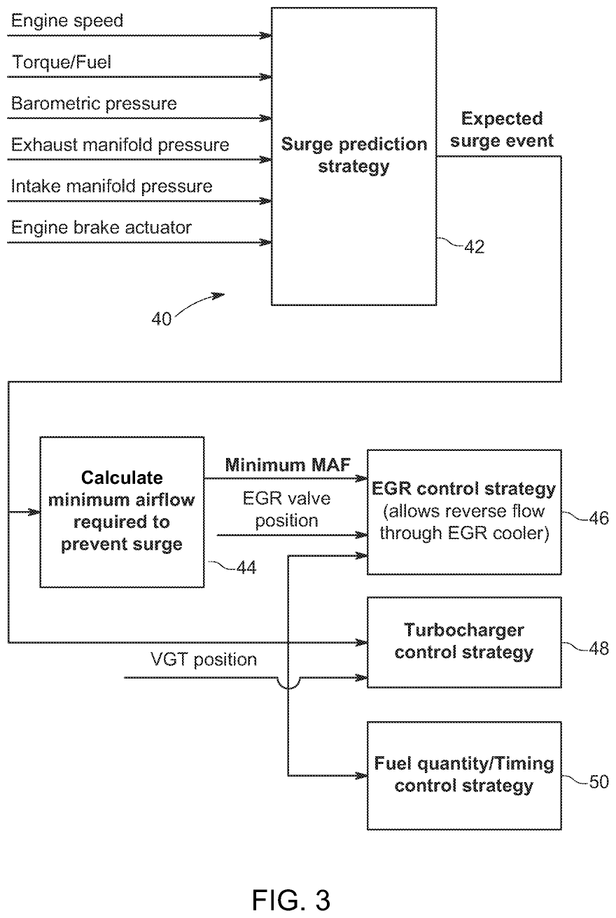

Certain turbochargers have a pressure release valve or “waste gate” which opens to relieve the excessive boost pressure by venting charge air. But that happens only after compressor surge has already begun. FIG. 3 illustrates a general strategy diagram 40 for mitigating or thwarting turbocharger compressor surge before surge actually begins by detecting occurrences of certain engine/vehicle events which cause certain changes in certain parameters which disclose, with high probability, that compressor surge is expected to occur. Upon such detection, the strategy takes corrective actions intended to prevent or mitigate compressor surge from occurring.

Strategy diagram 40 comprises a surge prediction strategy 42 for disclosing an expected surge event by monitoring various events/parameters to predict a surge event when certain changes in monitored events/parameters occur. A parameter may be one which is a direct measure of a specific parameter, or one which is indicative of a measure of a specific parameter. Events/parameters, such as those marked in FIG. 3, include engine speed, engine torque/fuel, ambient barometric pressure, engine exhaust manifold pressure, engine intake manifold pressure, and engine brake actuation. As discussed further below, engine operating parameters for reducing the energy being fed to the turbine inlet are controlled to reduce the energy being fed to the turbine inlet upon the surge prediction strategy 42 detecting and expected surge event (examples of engine operating parameters which may be used to reduce the energy to the turbine inlet include adjustments to the EGR valve position and/or the turbine vane position and/or fuel injection timing) .

Data for engine speed is immediately available on a data bus of an engine controller.

Data for engine torque is also immediately available and can be inferred from requested engine fueling (torque/fuel).

Ambient barometric pressure data, engine exhaust manifold pressure data, and engine intake manifold pressure data, as measured by respective sensors, are also immediately available.

Engine brake activation/de-activation is disclosed by setting/resetting of an engine brake activated flag. Setting/resetting of the flag is commonly disclosed by the condition (ON or OFF) of an electronic switch in the engine control system.

EGR valve position may be determined by a sensor associated with a valve element whose position is controlled by an EGR actuator to control flow through the EGR valve. Alternatively, EGR valve position may be determined by the EGR valve position control signals, rather than sensing the actual position of the valve element.

Turbine vane position may be measured by a sensor associated with the turbine vanes to control flow through the turbine or alternatively the turbine vane position may be determined by the turbine vane control signals rather than sensing the actual position of the valve element.

With engine 12 operating within a zone of stable operating region 24 where the pressure ratio exceeds a pressure ratio limit (which pressure ratio limit is a fixed predetermined value based on empirical testing and the compressor map, and which is a discretionary limit value representing a compromise between a potential lower pressure ratio limit value which would trigger the entry condition for the surge prediction strategy more frequently than desired, and a potential higher pressure ratio limit value which would allow more surge than desired), a sudden decrease in mass air flow entering the engine intake system may cause the location of engine operation on compressor map 22 to move rapidly toward surge line 26, as explained earlier. One cause of such movement can be a sudden and sufficiently large decrease in requested engine torque as measured by a sudden decrease in an engine fueling request. In other words, the engine torque gradient (rate-of-change) suddenly or rapidly becomes increasingly negative beyond a limit at which, when exceeded in the negative direction, discloses that a surge event is to be expected. The negative torque gradient limit is a fixed predetermined value which may be derived from surge detection during empirical operation of the engine over varying negative torque gradients. In certain embodiments, it may be desirable to determine the negative torque gradient limit using an imaginary surge line, or surge safety margin line, which is offset to the right of the actual surge line (to the normal operation range side of the surge line) to provide a safety margin for mitigating inadvertent operation into the surge range.

Upon the simultaneous detection, by surge prediction strategy 42, of: 1) a torque gradient which is more negative than a negative torque gradient limit; and 2) a pressure ratio which exceeds the pressure ratio limit, a pre-surge flag is set in the engine controller. When set, the pre-surge flag indicates that a surge event is expected to occur but has not yet occurred. After the pre-surge flag has been set, there is a brief window of time, perhaps 0.2 seconds, during which it is possible to thwart the expected surge event before the engine becomes unstable and the compressor begins to lose energy (i.e. spools down).

Engine torque is defined to be positive when the engine is being fueled to deliver torque to the vehicle's drive wheels. Engine torque is defined to be negative when the engine is a load on the vehicle's drive wheels which is causing the vehicle to decelerate, such as when the vehicle is coasting or an engine brake is activated.

When surge prediction strategy 42 discloses an expected surge event, there are at least three engine variables which may be controlled (either independently or in combination) to mitigate or eliminate the anticipated surge event: 1) opening of the EGR valves; 2) opening of the vanes of the VGT turbine; and/or delaying fuel timing. For an embodiment of a system utilizing just 1) and 2) above, upon the surge protection strategy 42 disclosing an expected surge event the vanes of the VGT turbine are immediately moved to their fully open position (which may reduce backpressure). Simultaneously, a target value for a minimum mass airflow through the compressor, in the direction from compressor inlet to compressor outlet, which will avoid compressor surge is calculated by a calculation step 44.

When pressure ratio exceeds the predetermined pressure ratio threshold, the minimum MAF is determined by the MAF value where the pressure ratio intersects with the surge line of the compressor map for that pressure ratio. This minimum MAF is then converted to a de-normalized value (to account for temperature and pressure changes through the charge air cooler). This de-normalized MAF is compared to the volumetric flow value of the engine (which is a variable value calculated based on engine speed, volumetric efficiency and boost pressure at the engine intake). In conditions in which the de-normalized minimum MAF exceeds the volumetric flow value of the engine, adjustments may have to be made to reduce the value fo the de-normalized minimum MAF. This may be done by opening the EGR valve to reverse the flow of the de-normalized minimum MAF and passing it through the EGR valve. The degree of opening the EGR valve is dependent on the magnitude of the difference between the de-normalized minimum MAF and the value of the volumetric flow of the engine. Immediately upon the prediction of an expected surge event, the turbocharger is controlled by a control strategy 48 whose objective is to reduce energy which the turbine is delivering to the compressor. After that and after the calculation of the minimum de-normalized MAF, the EGR valve may be controlled by strategy 46 in coordination with control of the turbocharger by strategy 48 to relieve boost pressure of charge air in an attempt to thwart or mitigate the expected surge before the available window of time expires.

Alternatively, it may be desirable to provide coordinated control between one or more of: 1) movement of the EGR valve; 2) movement of the VGT vanes; and/or 3) delay of the fuel injection timing based on the operating conditions—rather than, or in addition to, initially immediately moving the EGR valve to its fully open position.

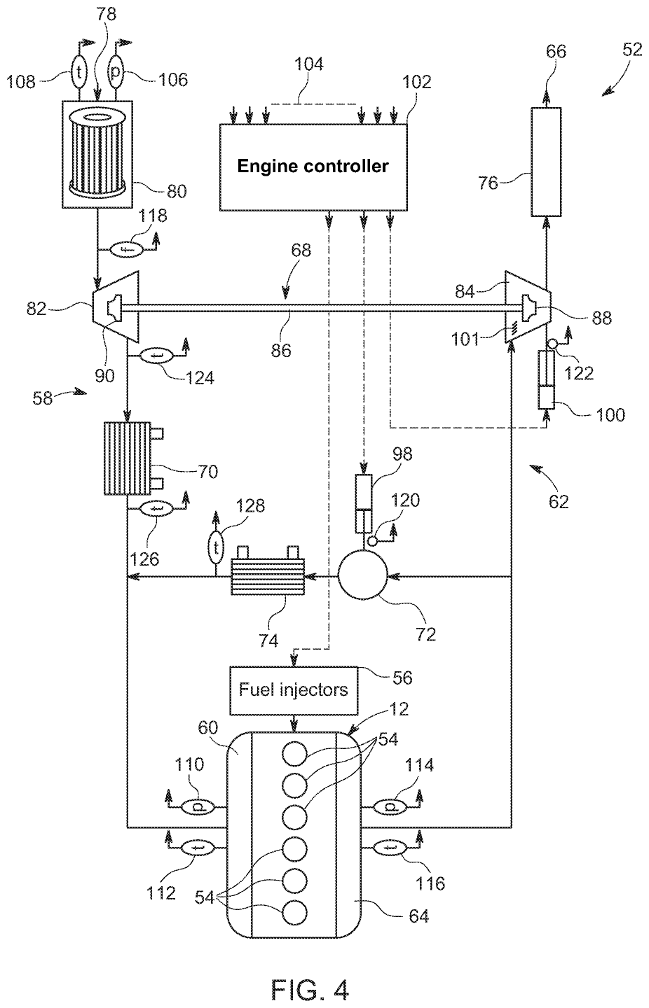

The strategy will be explained in more detail with reference to an engine system 52 shown in FIG. 4.

Engine 12 is a component of engine system 52 and is a diesel engine which contains engine cylinders 54 (six cylinders in this example) into which diesel fuel is injected by fuel injectors 56 for combustion with air which has been compressed by reciprocating pistons (not shown) to operate the engine through coupling of the pistons to a crankshaft (not shown) via connecting rods (not shown) to deliver engine torque through drivetrain 18 to rear drive wheels 20 of highway tractor 10. Engine system 52 further comprises an engine intake system 58 serving engine cylinders 54 through an engine intake manifold 60. Engine cylinder intake valves (not shown) control admission of a fluid mixture which has an air component and an engine exhaust component from intake manifold 60 into engine cylinders 54.

Engine system 52 further comprises an engine exhaust system 62 (also shown in FIG. 1). Engine exhaust (i.e. products of combustion) resulting from combustion of diesel fuel in engine cylinders 54 is exhausted through engine cylinder exhaust valves (not shown) into an engine exhaust manifold 64 for ensuing passage through the exhaust system to an exhaust system outlet 66 which is open to surrounding atmosphere.

Additional engine system components include a turbocharger 68, a charge air cooler 70, an EGR valve 72, an EGR cooler 74, and an exhaust aftertreatment system 76 containing one or more aftertreatment devices.

Intake system 58 has a fresh air inlet 78 through which the air component of the air/exhaust mixture enters intake system 58 and an intake air filter 80 for filtering particulate matter from fresh air before the air enters an inlet of a compressor 82 of turbocharger 68. Compressor 82 is operated by engine exhaust flow through a turbine 84 of turbocharger 68 before exhaust flow is treated as it passes though aftertreatment system 76 where it is treated to remove particulate matter and to chemically reduce certain products of combustion. A shaft 86 couples a turbine wheel 88 of turbine 84 to an impeller wheel 90 of compressor 82. Operation of compressor 82 by turbine 84 forces charge air created by the compressor through an outlet of the compressor and into intake manifold 60. Some heat of compression in charge air is removed by flowing charge air through charge air cooler 70 before charge air enters intake manifold 60.

Engine system 52 has external exhaust gas recirculation (EEGR) which provides the exhaust component of the air/exhaust mixture delivered to intake manifold 60 by diverting a controlled quantity of exhaust gas from exhaust system 62 at a location upstream of turbine 80 to a point of introduction into intake system 58 which is downstream of the outlet of compressor 82. Quantity of recirculated exhaust gas is controlled by EGR valve 72 and is cooled by EGR cooler 74 before entering intake system 58 to mix with charge air. This configuration for exhaust gas recirculation is representative of “high-pressure” exhaust gas recirculation. Engine coolant is circulated through both EGR cooler 74 and charge air cooler 70 to transfer heat to a radiator (not shown) at which heat is finally rejected to outside air.

An actuator 98 functions to control flow through EGR valve 72 over a range extending from fully closed to fully open. An actuator 100 functions to control an adjustment mechanism in turbine 84, such as vanes 101 of a VGT turbocharger, for controlling torque delivered through shaft 86 from turbine wheel 88 to impeller wheel 90.

An engine controller 102 controls fuel injectors 56, actuator 98, and actuator 100 by processing data from various sources represented generally by reference numeral 104. Some of the data is from various pressure, temperature, and flow sources shown in FIG. 4.

Ambient barometric pressure and temperature data are provided by a pressure sensor 106 and a temperature sensor 108. Intake manifold pressure and temperature data are provided by a pressure sensor 110 and a temperature sensor 112. Exhaust manifold pressure and temperature data are provided by a pressure sensor 114 and a temperature sensor 116. Data for mass airflow entering compressor 78 is provided by a MAF sensor 118. Engine brake actuation is indicated by setting a flag as mentioned earlier, EGR valve position and turbine adjustment mechanism position are measured by respective sensors 120, 122 associated with actuators 98, 100. Temperature of charge air at the outlet of compressor 78 is measured by a temperature sensor 124. Temperature of charge air at the outlet of charge air cooler 82 is measured by a temperature sensor 126. Temperature of exhaust gas at the outlet of EGR cooler 74 is measured by a temperature sensor 128. While pressure ratio is defined as explained earlier, FIG. 4 shows no pressure sensor at the compressor inlet. Compressor inlet pressure may be approximated with sufficient accuracy by using barometric pressure, possibly with compensation for pressure drop across filter 80. Temperature sensors 126, 128 may be somewhat redundant and if so one of them might be unnecessary.

Upon the pre-surge flag being set, turbocharger adjustment mechanism 101 is controlled to begin reducing boost pressure by reducing turbine torque which operates compressor 82. If the pressure difference obtained by subtracting exhaust manifold pressure from intake manifold pressure (i.e. from charge air boost pressure) becomes negative, engine operation will begin to become unstable. While boost pressure can also be relieved by reversal of flow through EGR valve 72 so that charge air can flow through EGR valve 72 into engine exhaust system 62, such flow reversal cannot be accomplished as quickly as by reducing turbine torque to compressor 82 via control of turbine vanes 101. Consequently turbine adjustment occurs before flow reversal through EGR valve 72.

Certain conditions may have to be satisfied before flow reversal through EGR valve 72 can occur. One condition is that EGR valve 72, if open, must be closed. Also exhaust manifold pressure must be less than boost pressure. Once those and any other required conditions have been satisfied, a reverse flow flag is set, allowing EGR valve 72 to open and flow charge air from engine intake system 58 to engine exhaust system 62. It is after EGR valve opens that the strategy coordinates control of EGR valve 72 with control of turbine vanes 101.

Another way for the pre-surge flag to be set occurs when a compression release engine brake which had been actively braking a vehicle's engine is de-activated (i.e. switched from being active to inactive). During engine braking, the engine, by its coupling to a vehicle's drive wheels via a drivetrain, becomes a load which uses kinetic energy of the moving vehicle for vehicle deceleration. When an engine brake is actively braking an engine, a driver of a vehicle is not depressing the accelerator pedal (i.e. the accelerator pedal is released). An engine brake can be de-activated in different ways, such as by operation of a special engine brake on-off switch, applying the vehicle service brakes, or depressing the accelerator pedal.

Most effective engine braking occurs when boost pressure of charge air is maximized so that after such charge air which has been compressed in the engine cylinders and is released by the engine brake into exhaust manifold 64, the released air creates high exhaust manifold pressure. Under such pressure conditions, de-activation of the engine brake, in the absence of the strategy embodied in diagram 40 of FIG. 3 could result in compressor surge occurring before the engine can return to stable operation. Therefore by setting the pre-surge flag upon de-activation of the engine brake, the disclosed strategy is enabled to prevent, or at least mitigate, a surge event. The pre-surge flag is most quickly set by using change in the control signal to the engine brake.

Another way for the pre-surge flag to be set occurs when cruise control is actively operating a vehicle at a selected cruising speed and cruise control is de-activated (i.e. cancelled) by switching cruise control from “on” to “off”. If the accelerator pedal is not being depressed at the time of cruise control de-activation, engine fueling for accelerating the vehicle is not being requested. Therefore, the engine becomes a load which begins to decelerate the vehicle as soon as cruise is cancelled. Cruise control de-activation causes the pre-surge flag to be set as a function of how much torque the engine was delivering at the time of cruise de-activation. For example, if the vehicle were climbing a steep grade, the engine would be delivering more torque to maintain cruise speed than if the vehicle were not traveling on the grade, and if the engine brake was active at the time of cruise de-activation, boost pressure could be great enough to set the pre-surge flag upon cruise de-activation.

When a vehicle is in motion, it may also be decelerated by downshifting its transmission to a lower gear. During the downshift, the transmission is temporarily between gears, preventing the engine from delivering torque to the vehicle's drive wheels. If the duration of the downshift is long enough, that too will set the pre-surge flag.

Because opening of EGR valve 72 for relieving charge air boost pressure can occur once the reverse flow flag has been set, the reverse flow flag will be reset if either stable operation either has been maintained, or else restored after unstable operation, so as to avoid excessive EGR and attendant poor combustion. Exhaust manifold pressure greater than intake manifold pressure also resets the reverse flow flag.

The pre-surge flag is also reset once a predicted surge event has been avoided, or if not avoided, has been corrected. If turbine vanes 101 are kept open too long, the engine may be unable to regain stability because the turbine would not be delivering enough torque to enable the compressor to deliver sufficient fresh air for the engine to perform well. Hence the pre-surge flag is reset before that occurs. When the torque gradient becomes ceases to be less negative than the negative torque gradient limit, or if the pressure ratio ceases to be greater than the pressure ratio limit, the pre-surge flag is reset.

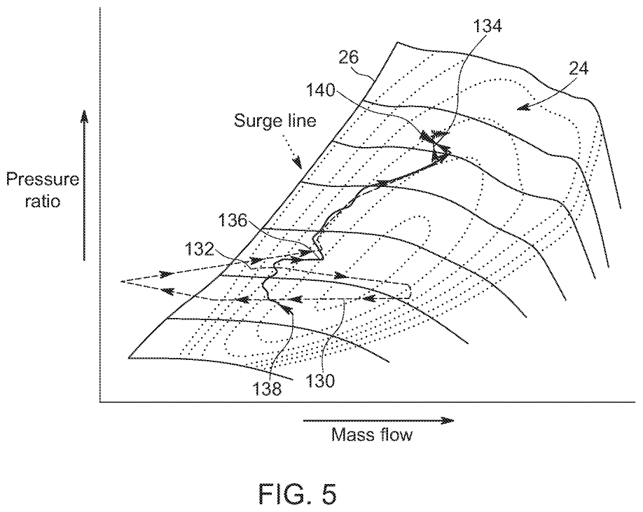

An example of how the disclosed strategy thwarts compressor surge is depicted on the compressor map of FIG. 5. As in FIG. 2, a stable operating region 24 for the compressor is bounded on the left by a compressor surge line 26, and on the right by a compressor choke line 28. A first trace 130 begins at a location 132 and ends at a location 134. A second trace 136 begins at a location 138 and ends at a location 140.

The path of trace 130 in the direction of its arrows defines a timeline of pressure ratio and mass airflow when an engine system lacks the disclosed surge prediction strategy. When trace 130 first crosses surge line 26, engine operation starts to become unstable with the compressor losing energy which is not recoverable. Eventually the engine returns to stable operation when trace 130 re-enters stable operating region 24.

The path of trace 136 in the direction of its arrows defines a timeline of pressure ratio and mass airflow when an engine system has the disclosed surge prediction strategy. Trace 136 does not leave stable operation region 24, and therefore the compressor avoids the extreme loss of energy as it would in the absence of the surge prediction strategy.

Throughout this description, it will be understood that whenever the surge line is referenced, it may be the actual surge line or it may alternatively be a line which is offset from the actual surge line by a margin of error.

What is claimed is:

1. A vehicle which comprises:
an engine system comprising an internal combustion engine which has an intake manifold and an exhaust manifold and which develops output torque which is delivered through a drivetrain to drive wheels which propel the vehicle;
the engine system further comprising an intake system, which includes the intake manifold and combustion chambers into which air that has passed through the intake system enters to combust with fuel that has also entered the combustion chambers to develop output torque, and further comprising, an exhaust system, including the exhaust manifold, for conveying products of combustion out of the engine system;
a turbocharger comprising a turbine operated by products of combustion conveyed through the exhaust system and a compressor in the intake system operated by the turbine for creating boost pressure for charge air entering the combustion chambers; and
a control system for processing data which indicates an expected compressor surge event before compressor surge begins, and which, when processing of such data discloses an expected compressor surge event while the compressor is operating in a stable region of a compressor map that characterizes operational characteristics of the compressor, controls one or more aspects of the engine system to maintain compressor operation in the stable region of the compressor map without transgressing a compressor surge line on the compressor map which, if transgressed, would cause compressor surge to occur.

2. The vehicle as set forth in claim 1 in which data which can disclose expected compressor surge before compressor surge begins comprises data representing changes in difference between intake manifold pressure and exhaust manifold pressure.

3. The vehicle as set forth in claim 2 in which data representing changes in engine operating parameters comprises data representing change in engine speed and data representing change in engine torque.

4. The vehicle as set forth in claim 2 in which the vehicle has an engine brake, and data representing changes in engine operating parameters comprises data representing change from the engine brake being active to the engine brake being inactive.

5. The vehicle as set forth in claim 2 in which the vehicle has a cruise control system, and data representing changes in engine operating parameters comprises data which discloses the cruise control system being switched from on to off.

6. The vehicle as set forth in claim 2 in which the drivetrain has a transmission which can be shifted between different gears, and data representing changes in engine operating parameters comprises data which discloses that the transmission is temporarily between gears during a gear shift.

7. The vehicle as set forth in claim 1 in which the control system is effective to cause the turbocharger turbine to begin reducing torque to the compressor upon disclosure of expected compressor surge.

8. The vehicle as set forth in claim 1 in which the engine system further comprises an EGR valve for controlling flow of products of combustion from the exhaust manifold to the intake manifold, and the control system is effective upon disclosure of expected compressor surge to immediately open the EGR valve to its fully open position.

9. The vehicle as set forth in claim 1 in which the turbocharger comprises a variable geometry turbocharger having moveable vanes and control of the engine system to maintain compressor operation in the stable region of the compressor map without transgressing a compressor surge line on the compressor map comprises further opening the vanes of the variable geometry turbocharger.

10. The vehicle as set forth in claim 9 in which the vanes of the variable geometry turbocharger are moved to the fully open position.

11. The vehicle as set forth in claim 1 in which the engine system comprises fuel injectors to inject fuel into the combustion chambers to develop output torque and control of the engine system to maintain compressor operation in the stable region of the compressor map without transgressing a compressor surge line on the compressor map comprises further delaying fuel injection timing.

12. The vehicle as set forth in claim 1 in which the control of the engine system to maintain compressor operation in the stable region of the compressor map without transgressing a compressor surge line on the compressor map comprises providing the engine system with an EGR valve for controlling flow of products of combustion from the exhaust manifold to the intake manifold and immediately moving the EGR valve to its fully open position upon the detection of an expected surge event, and in which one or both of: 1) the turbocharger of the engine system comprises a variable geometry turbocharger having moveable vanes which are moved to a more open position following movement of the EGR valve to its fully open position; and 2) the engine system further comprises fuel injectors to inject fuel into the combustion chambers to develop output torque and the timing of the injection of fuel into the combustion chambers by the fuel injectors is delayed.

13. In a vehicle having an engine system comprising an internal combustion engine which has an intake manifold and an exhaust manifold and which develops output torque which is delivered through a drivetrain to drive wheels which propel the vehicle, an intake system, which includes the intake manifold, and combustion chambers into which air that has passed through the intake system enters to combust with fuel that has also entered the combustion chambers to develop output torque, and an exhaust system, including the exhaust manifold, for conveying products of combustion out of the engine system, the engine system further having a turbocharger comprising a turbine operated by products of combustion conveyed through the exhaust system and a compressor in the intake system operated by the turbine for creating boost pressure for charge air entering the combustion chambers, a method for disclosing expected compressor surge before compressor surge begins, the method comprising:
processing data which can disclose expected compressor surge while the compressor is operating in a stable region of a compressor map that characterizes operational characteristics of the compressor, and upon disclosure of expected compressor surge, controlling the engine system to maintain compressor operation in the stable region of the compressor map without transgressing a compressor surge line on the compressor map which, if transgressed, would cause compressor surge to occur.

14. The method as set forth in claim 13 in which processing data which can disclose expected compressor surge while the compressor is operating in a stable region of a compressor map comprises processing data representing change in difference between intake manifold pressure and exhaust manifold pressure.

15. The method as set forth in claim 14 in which processing data which can disclose expected compressor surge while the compressor is operating in a stable region of a compressor map comprises processing data representing change in engine speed and data representing change in engine torque.

16. The method as set forth in claim 15 in which the vehicle has an engine brake, and in which processing data which can disclose expected compressor surge while the compressor is operating in a stable region of a compressor map comprises processes data representing change from the engine brake being active to the engine brake being inactive.

17. The method as set forth in claim 15 in which the vehicle has a cruise control system, and in which processing data which can disclose expected compressor surge while the compressor is operating in a stable region of a compressor map comprises processing data which discloses the cruise control system being switched from on to off

18. The method as set forth in claim 15 in which the drivetrain has a transmission which can be shifted between different gears, and in which processing data which can disclose expected compressor surge while the compressor is operating in a stable region of a compressor map comprises processing data which discloses that the transmission is temporarily between gears during a gear shift.

19. The method as set forth in claim 15 comprising causing the turbocharger turbine to begin reducing torque to the compressor upon disclosure of expected compressor surge.

20. The method as set forth in claim 15 in which the engine system further comprises an EGR valve for controlling flow of products of combustion from the exhaust manifold to the intake manifold, and upon disclosure of expected compressor surge, closing the EGR valve and then upon pressure in the exhaust manifold becoming less than boost pressure of charge air in the intake manifold, opening the EGR valve for flow of charge air to the engine exhaust system.
